(19) United States
(12) Patent Application Publication
(10) Pub. No.: US 2004/0248496 A1
(43) Pub. Date: Dec. 9, 2004

(54) Remote-controlled long-range airplane

(76) Inventor: William B. Harvey, Olney, MD (US)

Correspondence Address: ZITO TLP, 26005 RIDGE ROAD, SUITE 203, DAMASCUS, MD, 20872, US

(21) Appl. No.: 10/768,741

(22) Filed: Feb. 2, 2004

Related U.S. Application Data
(63) Continuation-in-part of application No. 09/962,534, filed on Sep. 25, 2001, now Pat. No. 6,685,528.

(51) Int. Cl. A63H 27/00

(52) U.S. Cl. 446/61

(57) ABSTRACT

An unmanned, remote-controlled, long-range or long-flight duration airplane is designed to efficiently carry a large amount of fuel and payload for long duration flights. Structural wing design comprises an integral structure of recessed and interconnected geometric shapes, such as hexagonal cells. Wings are formed together as a single unit, with each wing formed in an arc design as it extends from the fuselage.

### RELATED APPLICATIONS

### CROSS-REFERENCE TO RELATED APPLICATIONS

This application is a continuation-in-part of application Ser. No. 09/962,534 filed Sep. 25, 2001.

### FIELD OF THE INVENTION

The present invention relates to the field of remote controlled aircraft. More specifically, the present invention relates to an unmanned, long-flight duration airplane.

### BACKGROUND OF THE INVENTION

Remote-controlled airplanes are generally designed for a specific purpose, whether for entertainment or sport, or for a more serious purposes such as military reconnaissance or delivery of ordinance. Such designs are often complex, involving requirements for precision maneuverability, high reliability or cargo space for payloads. The built-in complexity is costly, but required for the nature of the use contemplated. Sometimes the designs are simple, with a purposeful lack of utility or dependability. Generally these designs are less costly and thus more cost-effective for the purpose intended.

However, the nature of all these designs tend to make the airplanes inappropriate in the event that they are used for purposes other than the one intended by the design. For example, an airplane designed for durability may not be appropriate for use in a sacrificial situation or an airplane designed for maneuverability may not function well in a long-rang flight application. In addition, if inappropriately designed airplanes are used in large numbers, their use may become prohibitively costly. As an exemplary issue, there is currently no suitable design available which allows cost-effective utilization of large numbers of remote-controlled airplanes in experimental applications involving long-range or long-flight duration scenarios.

### SUMMARY OF THE INVENTION

Addressing the problems with the prior art an embodiment of the present invention compromises an unmanned, remote-controlled airplane designed primarily to achieve long-range/long-duration flight and which is able to be mass produced economically for experimental use in large quantities.

A remote-controlled, long-flight duration airplane is disclosed having the traditional remote controlled airplane features of a fuselage, a pair of wings, a pair of horizontal stabilizers and a vertical stabilizer. The airplane is propelled and maneuvered during flight by an engine and flight control system of the types familiar to anyone skilled in the art. The engine and flight control systems are connected to a remote controlled on-board navigation system, which may also be of any type commonly used in remotely guided airplanes, including GPS assisted tracking and guidance system types. A unique aspect of the present invention is a design focused on achieving an economically mass-produced vehicle capable of long-range and/or long-duration flight in instances where cost-effective experimental testing is desired on large numbers of airplanes at the same time. The long-range/long-duration flight ability of the airplane is achieved by the aerodynamic characteristics of the air craft and by optimizing the size and shape to carry the maximum amount of fuel within weight restrictions.

In an exemplary embodiment described herein, the main body of the fuselage is a cylinder, relatively long and narrow in diameter, which is designed to bE used primarily for housing the fuel tank, which occupies a significant amount of the free space inside the fuselage. The on-board navigation system and the rear rudder and elevator control rods are also present within the fuselage, but their space utilization is kept to a minimum. The large amount of fuel stored within the fuselage adds weight to the aircraft, which must be addressed in the design of the wings.

The wings, on opposite sides of the airplane are relatively long and thin and are curved longitudinally in an arc. This design maximizes the strength of the wings relative to their size, weight and aerodynamic lift characteristics. The vertical stabilizer and horizontal stabilizer are relatively standard sections, each with rudder and elevator flaps that are attached to the flight control system. Economical mass-production of the airplane is achieved primarily through the use of thin gauge molded plastic and a strong but lightweight hexagonal cell design of the cell inner core of the wings, the horizontal stabilizers and the vertical stabilizer.

### BRIEF DESCRIPTION OF THE DRAWINGS

Exemplary embodiments of the invention are discussed hereinafter in reference to the drawings, in which:

FIG. 1 is a view of the remote controlled airplane—right side view,

FIG. 2 is a view of the remote controlled airplane—left front side view,

FIG. 3 is a view of the fuel tank with foam baffles seen as shaded areas along the body of the tank,

FIG. 4 is a view of the nose cone prior to attachment,

FIG. 5 is a view of the upper fuselage section, inverted, with the bulkhead and the inner core of the rear horizontal stabilizer shown glued in place before final assembly,

FIG. 6 is a view of the upper fuselage section, inverted, with the vertical stabilizer support stiffener shown glued in place within the section and the inner core of the rear horizontal stabilizer shown glued in place before final assembly,

FIG. 7 is a view of the middle fuselage section including the fuel tank seat and the fuel tank mounting pegs shown glued in place,

FIG. 8 is an underside view of the middle fuselage section showing the underside of the fuel tank seat,

FIG. 9 is a view of the lower fuselage section with wing penetration slots and screw attachment recesses shown,

FIG. 10 is an exploded view of the fuselage and rear horizontal stabilizers with the upper fuselage sections seen separated from the middle and lower fuselage sections. The vertical stabilizer mounting nub is seen atop the rear of the upper fuselage section,

FIG. 11 is a view of the upper and lower wing sections,

FIG. 12 is a view of the inner core of the wing unit,

FIG. 13 is an exploded view of the vertical stabilizer with its inner core section before assembly and cutting to form the front section of the stabilizer and the rudder,

FIG. 14 is a view of the tail of the upper fuselage section with a completed vertical stabilizer and rudder mounted in place on the vertical stabilizer mounting nub,

FIG. 15 is a sidE view of the fuselage and horizontal stabilizer indicating the slot for the wing penetration and the vertical stabilizer mounting nub,

FIG. 16 is a cut-away view of the separation area of the inner core of the vertical and horizontal stabilizers showing the slots created at the cuts through the alternating rectangular embossed areas with the hinge strips installed in the slots.

### DETAILED DESCRIPTION OF PREFERRED EXEMPLARY EMBODIMENTS

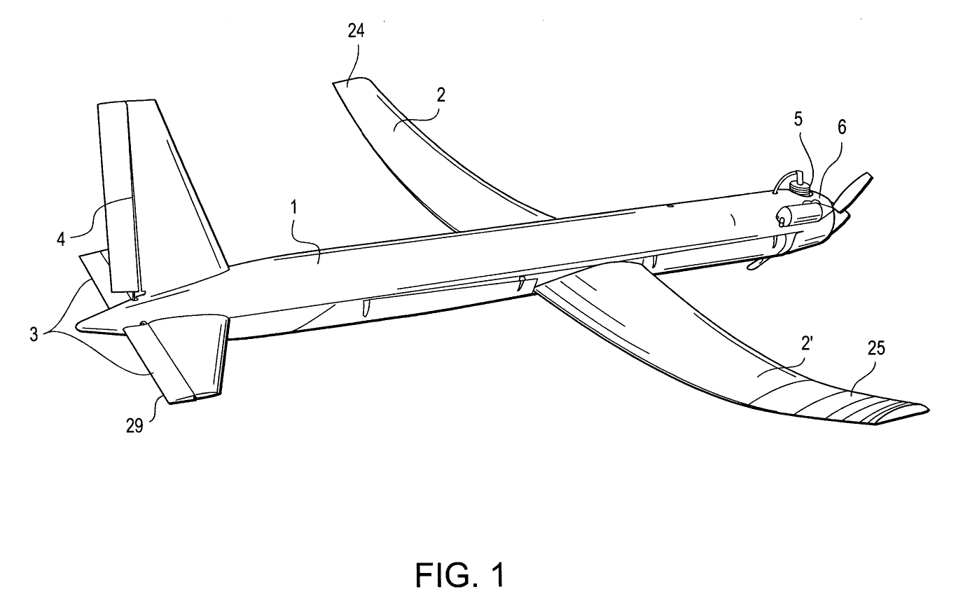

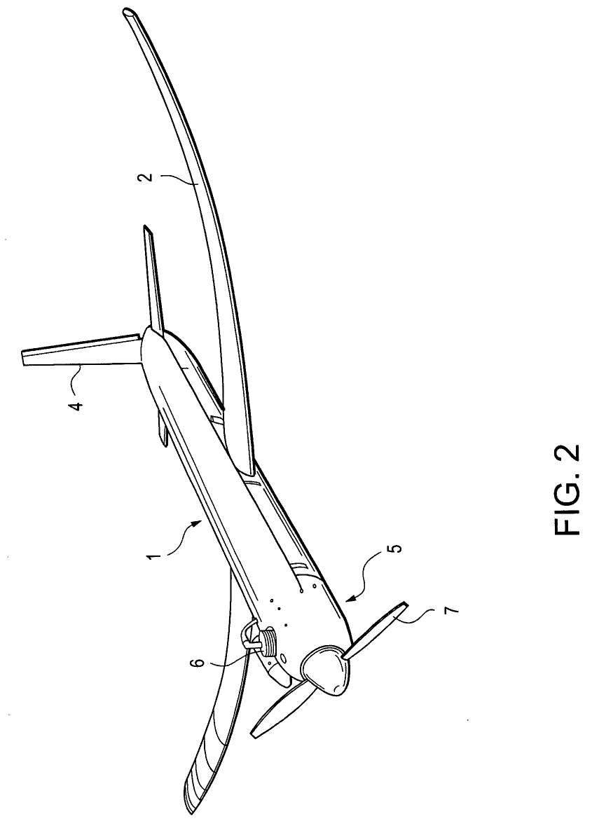

In the exemplary embodiment depicted in FIGS. 1 and 2, the airplane of the present invention comprises a fuselage 1, a pair of wings 2, a pair of horizontal stabilizers 3, a vertical stabilizer (rear rudder) 4 and a nose cone 5. The airplane is propelled and maneuvered during flight by the engine 6 and propeller 7, a remote controlled on-board navigation system (not shown) and an integrated flight control system (not shown).

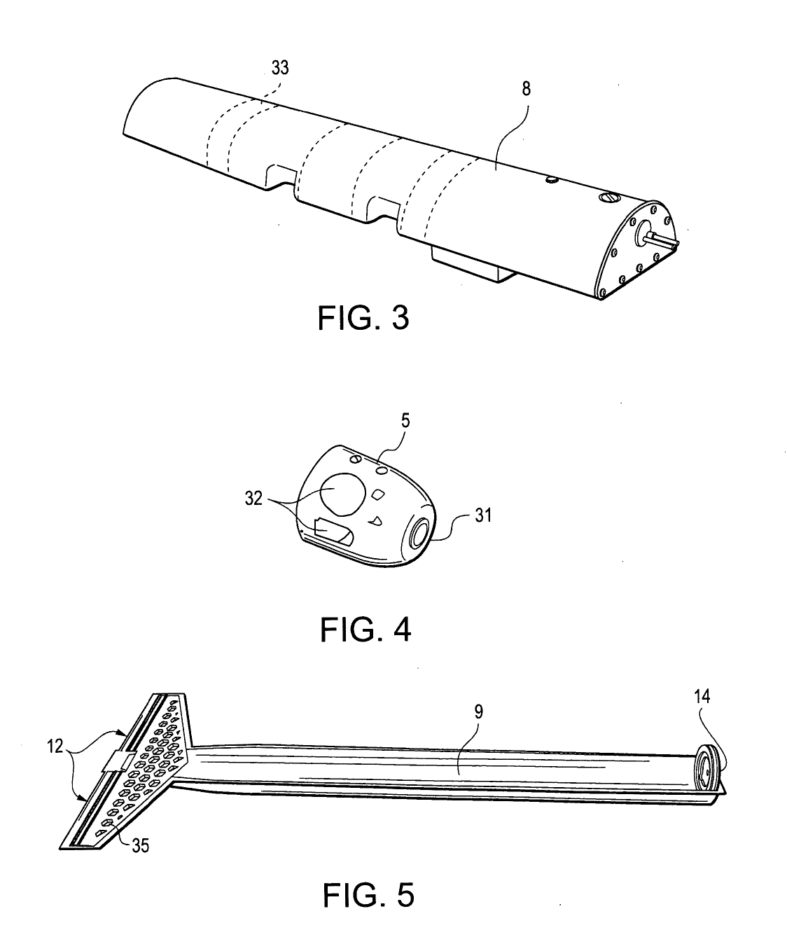

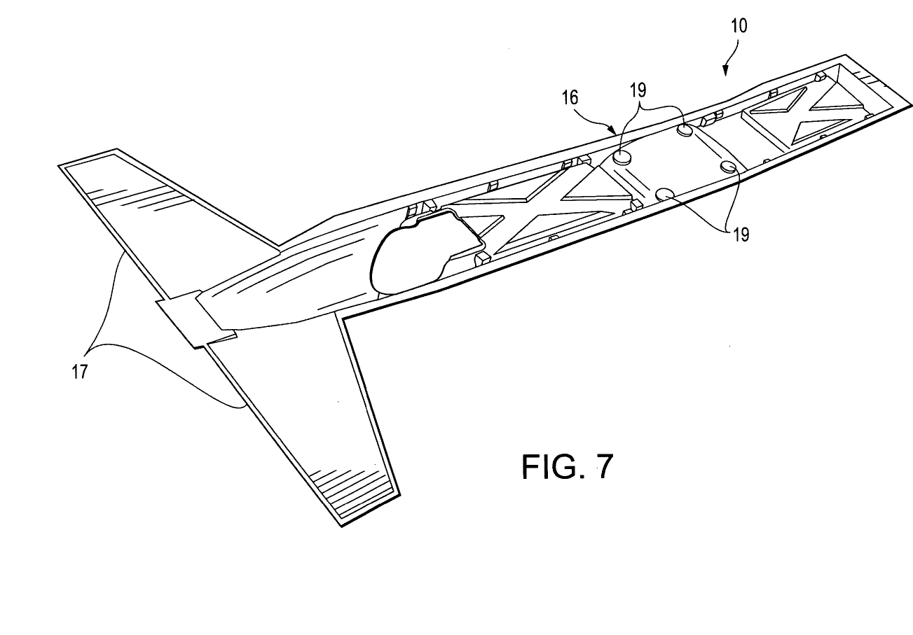

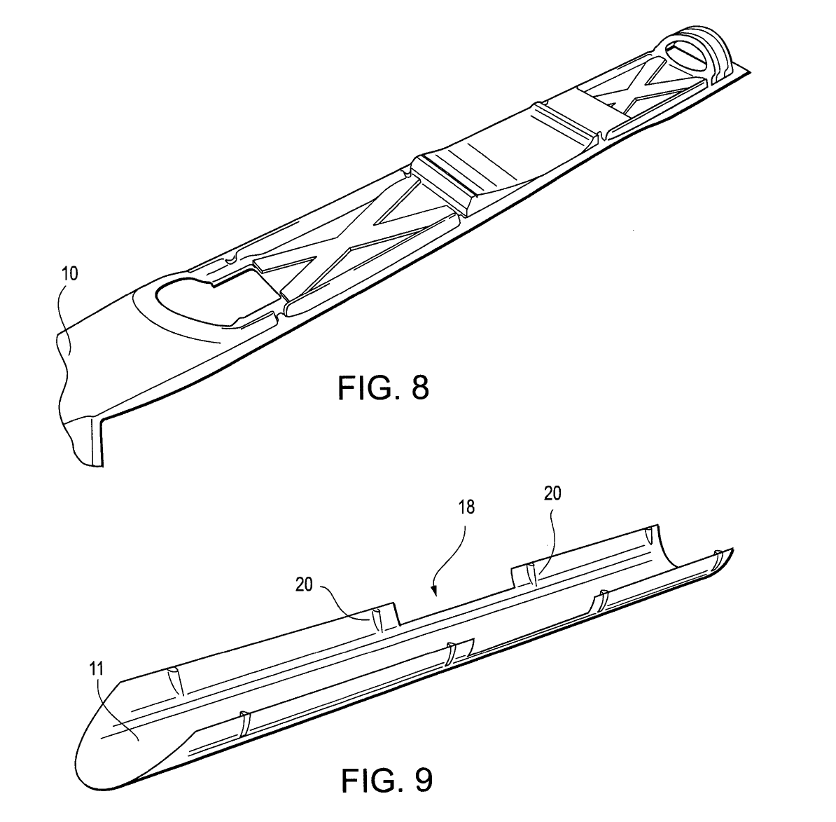

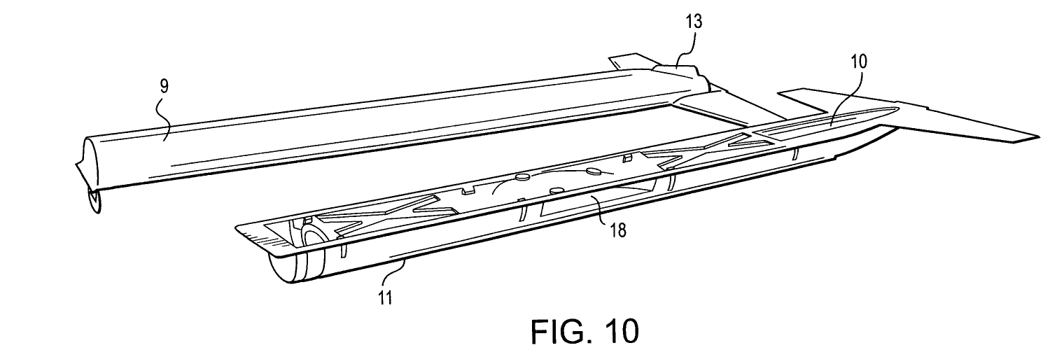

The fuselage 1 is a cylinder, relatively long and narrow in diameter, made of thin gauge plastic. The fuselage houses the fuel tank 8 shown in FIG. 3, the on-board navigation system and the rear rudder 4 and elevator control systems (not shown), which are a part of the flight control system. The fuselage is comprised of three parts—the upper fuselage section 9 shown inverted in FIG. 5, the middle fuselage section (10) shown in FIG. 7 and the lower fuselage section 11 shown in FIG. 9.

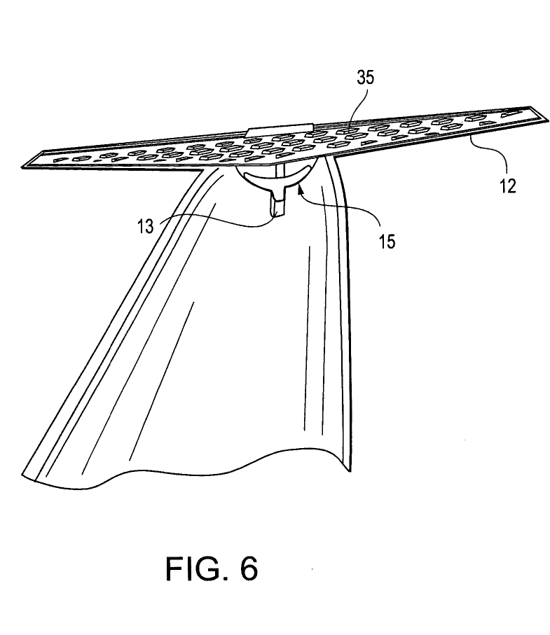

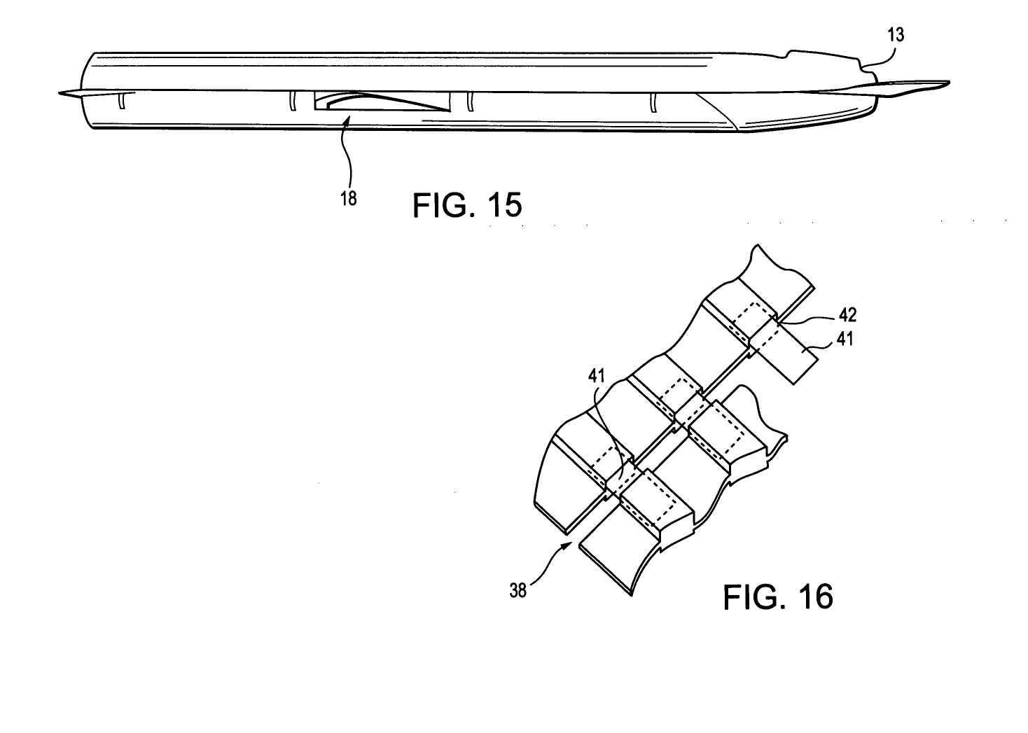

As shown in FIGS. 5 and 6, the upper fuselage section 9 contains the upper portions of the rear horizontal stabilizers 12 and a mounting nub 13 shown in FIGS. 6 and 15 for the vertical stabilizer 4. Each feature is cast integrally with the upper fuselage section. At the front of the fuselage, installed between the upper 9 and middle fuselage sections is a bulkhead 14, shown in FIG. 5, and manufactured using wood, plastic, or any other stiff, lightweight material. At the inner rear of the upper fuselage section 9, is a vertical stabilizer support stiffener 15, located just beneath the vertical stabilizer mounting nub 13. The support stiffener is designed to fit the inner shape of the rear of the upper fuselage section, including fitting into the area embossed for the vertical stabilizer mounting nub. The vertical stabilizer support stiffener is manufactured using wood, plastic or any stiff, lightweight material.

The middle fuselage section 10 contains the seat for the fuel tank 8 and the lower portions of the rear horizontal stabilizers 17. The seat 16 consists of features molded into the top surface of the middle section, designed to be compatible with the bottom side of the fuel tank 8 and the top of the wing penetration 18 shown in FIGS. 9 and 15. Fuel tank mounting pegs 19 are glued onto the seat 16. The thin, circular pegs may be made of wood or any other suitable material.

The lower fuselage section 11 comprises the belly of the aircraft. It houses the flight control mechanism (not shown) and contains a slot in the fuselage 18 through which a wing 2 passes and connects with the body of the plane. It contains pre-cast recesses 20 for installing screws (not shown) which fasten the lower fuselage section 11 to the upper fuselage section 9.

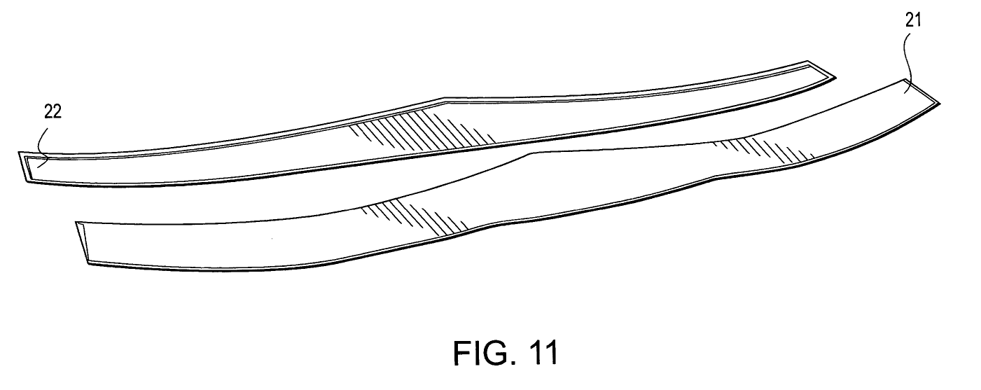

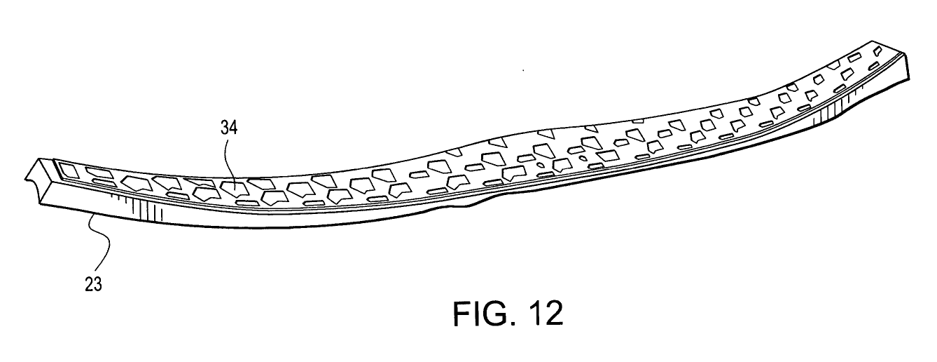

FIGS. 11 and 12 illustrate the wings 2 of the airplane that are constructed as a single fabricated unit which passes through and projects from opposing sides of the fuselage 1. As shown in FIG. 11, the wing unit 2 comprises an upper wing section 21, a lower wing section 22 and, as shown in FIG. 12, a lightweight, hexagonal-cell inner core design for the supporting structure 23 which is installed between the upper and lower sections. When assembled, the wing unit 2 comprises a left wing portion 24, a right wing portion 25, and a central portion which is located inside the fuselage 1 as indicated in FIG. 1. Each wing 2 is curved on its longitudinal axis in an arc.

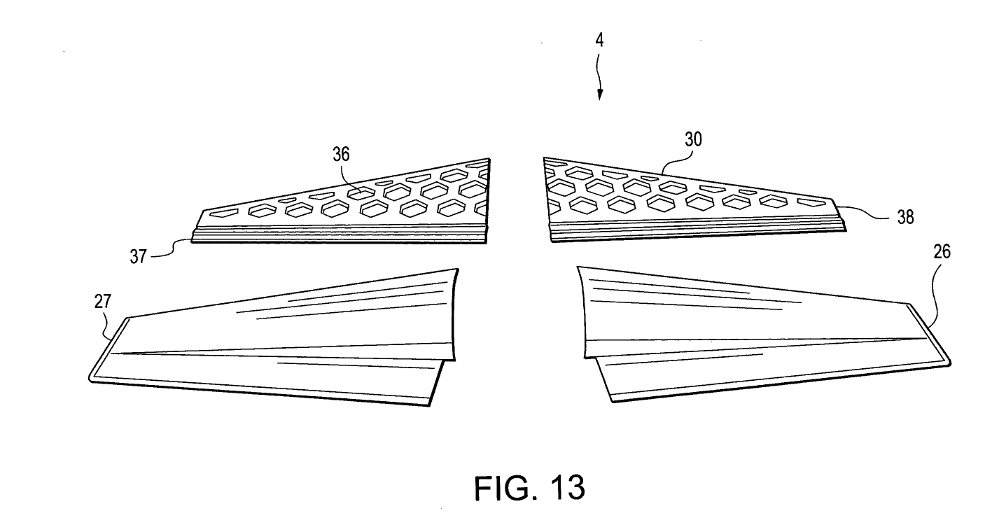

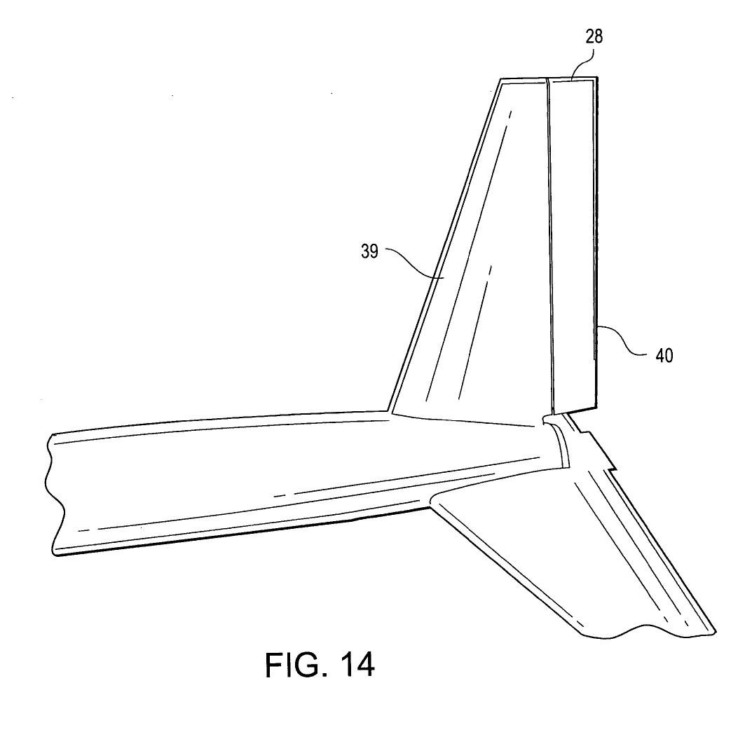

The vertical stabilizer 4 and horizontal stabilizers 3 are each made of two symmetrical halves. The vertical stabilizer, shown in FIG. 13, is made of left and right halves 26 and 27, respectively and the horizontal stabilizers are made of upper and lower sections 12 and 17, respectively as noted above. After final assembly, the vertical stabilizer includes a rudder flap 28, as shown in FIG. 14, and the horizontal stabilizer includes an elevator flap 29 as shown in FIG. 1. All flaps are attached to the internal flight control system mechanism (not shown) which passes through the fuselage 1 to the rear of the airplane. The vertical and horizontal stabilizers' designs also incorporate the use of a strong, lightweight hexagonally celled inner core 30, as shown in FIG. 13, which provides strength to the sections.

The nose cone 5 is shown in FIG. 4. It is constructed with thin gauge molded plastic, formed in the shape of a half capsule with a rounded front end 31 and straight cylindrical sides. Holes 32 are cut through the surface of the nose cone to accommodate aircraft elements such as the engine 5 and the propeller 6.

As illustrated in FIG. 3, the fuel tank 8 is relatively long and narrow utilizing the majority of the space inside the fuselage 1 between the upper 9 and lower 11 fuselage sections. The high fuel storage capacity enables the airplane to fly on long-range and/or long-duration flights. Internal to the fuel tank 8 are permeable foam baffles 33, seen as shaded areas in FIG. 3, which are designed to limit the destabilizing effects of the sloshing of fuel during flight.

The engine 5 and the flight control system may be of any types familiar to anyone skilled in the art of relatively small, remote controlled, unmanned aircraft. The engine and flight control system are connected to a remote controlled on-board navigation system, which may also be of any type commonly used in remotely guided airplanes. An example includes GPS-assisted tracking and guidance navigation system types.

Each of the wings 22 is shaped as a parabolic curve or arc. The thin gauge plastic surface is formed in the shape of a wing unit which, when trimmed, forms the inner core support structure for the wings. The inner core has a structure which comprises a series of geometrically-shaped recesses 34 arranged in a honeycomb fashion. In a preferred embodiment, the recesses 34 are constructed as hexagonal cells.

Inner core sections 30, shown in FIG. 13 for the vertical stabilizer 4 and the inner core sections 35, shown in FIGS. 5 and 6 for the horizontal stabilizers 3 are also thin gauge plastic surfaces comprising a series of geometrically-shaped recesses. Sections 30 are molded in two symmetrical halves as in FIG. 13 which, when glued together and trimmed, form the inner core support structure for the vertical stabilizer 4. Horizontal stabilizers 3 are formed in a similar manner. Each symmetrical half is split into a front 36 and rear 37 portion as shown in FIG. 13, with each portion having distinct structural patterns. The front portion 36 of each half contains the recessed/honeycomb features similar to the wing inner core 23 described above.

When the two inner core halves 36, 37 are joined, the symmetrically opposed honeycomb recesses of two the front halves 36 abut back-to-back creating a very stiff composite inner core section. The rear portion 37 of each inner core half contains a series of ridges (not shown) which are embossed into the surface and which run parallel to the direction of the long dimension of the part. In between the front and rear portions 36, 37 there is a narrow separation segment 38 incorporating a series of alternating embossed and non-embossed rectangular areas (not shown) running along its length.

The inner core 30 of the stabilizers is constructed by gluing the two symmetrical sections of the inner core together and trimming around the edges, if necessary.

The vertical stabilizer 4 and horizontal stabilizers 3 are formed by placing their respective core structures in between the symmetrical halves of each stabilizer section (e.g., 26 and 27) and attaching the entire assembly together. In the case of the horizontal stabilizers 3, the top 9 and middle 10 sections of the fuselage are joined together. The assembled vertical and horizontal stabilizer sections 3, 4, together with their respective cores 30, 35 which have been installed inside, are then cut into two parts along a line parallel to the rear edge of each stabilizer and passing through the center of the separation area of the inner core 38. This effectively divides the vertical and horizontal stabilizers into separate front and rear sections 39 and 40 as shown generally for all stabilizers in FIG. 14. The rear sections (e.g., 40) of the stabilizers become the rudder 40 in the case of the vertical stabilizer and the elevators 29 in the case of the horizontal stabilizers.

Flexible hinge strips 41 as shown in FIG. 16 made of plastic or any other suitable material are attached between the front and rear sections of each stabilizer. This is accomplished by sliding the hinge strips into the series of slots (42) created at the cut edges of the three assemblies' core sections where the embossed areas of the core's symmetrical separation segments 38 were attached. The hinge strip connects the front and rear stabilizer sections (e.g., 39 and 40, respectively) together but allows the rear (rudder and elevator) sections (40 and 29) to swing in an arc perpendicular to the plane of their respective stabilizers. The actual movement of the rudder and elevators is controlled by control rods leading to the flight control system (not shown) housed within the fuselage.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

1. A ready-to-fly unmanned, plastic airplane, comprising:
an upper fuselage section;
a middle fuselage section, attached to the upper fuselage section, formed with a seat for a fuel tank;
a lower fuselage section, attached to the middle fuselage section, formed integrally with the middle fuselage section;
an upper rear horizontal stabilizer section, formed integrally with the upper fuselage section;
a lower rear horizontal stabilizer section, formed integrally with the middle fuselage section, attached to the upper horizontal stabilizer section;
a vertical stabilizer, formed integrally with the upper fuselage section;
a pair of wings formed as a unit, inserted through a slot in the lower fuselage section, formed with a geometrically-celled structure as an inner structural core between a lower section and an upper section of the wings,
wherein a mid-section of the unitized wings attach to the lower fuselage section, and
each wing is formed in an rising arc on the wing's longitudinal axis as the wing extends away from the lower fuselage section.
